(19) United States
(12) Patent Application Publication
(10) Pub. No.: US 2007/0176767 A1
(43) Pub. Date: Aug. 2, 2007

(54) Device for automating building engineering

(76) Inventors: Udo Baumgaertner, Kronau (DE); Gregor Stiehl, Sinsheim-Steinsfurt (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/597,685

(22) PCT Filed: Jan. 21, 2005
(86) PCT No.: PCT/DE05/00081

§ 371 Date: Aug. 3, 2006

(30) Foreign Application Priority Data
Feb. 3, 2004 (DE) 10 2004 005 219.0

(51) Int. Cl. G08B 1/08; G08B 19/00

(52) U.S. Cl. 340/538; 340/521

(57) ABSTRACT

The device has, for each room, a room module (10, 24) with an integrated sensor system (18) and electrical power terminals (20, 22), among other things, for an actuating system with no more than the poles of the electric power mains. The room module(s) (10, 24) is/are placed directly with a central module (36) or with distributor modules (32) in a data bus (16) that, itself, is located with the central module (36) in a data bus (34).

The invention relates to a device for automating building services and possibly safety monitoring of a building, of an industrial plant, of a building and/or plant complex or a working unit thereof, which has at least one room.

The concept of intelligent automation of the building services of residential and/or business buildings has been pursued with various approaches for at least 15 years. Networking of originally separate open- and closed-loop control functions makes it possible to achieve leaps in improvements in living comfort, effectiveness of energy use and safety. The automation is driven by the steep increase in the degree of integration of digital electronics with ever greater storage capacity and higher computing speed of the processors at the same or even decreasing costs.

The “European installation bus” (EIB, also called INSTABUS), a decentralized bus system for automating building services is well known in technical circles. Distributed along the bus there are sensors and actuators, all of which have their own microprocessor. For this reason, the EIB is considered as a bus system with decentralized intelligence. All participants are connected to one another by a two-wire cable via which both the electrical supply and the data exchange takes place. The participants are identified by an unambiguous physical address on the bus.

The sensors pick up measurement quantities such as temperature or brightness and incorporate the measurement signal in a message which is sent on the bus. All actuators having a corresponding destination address receive the information of the message and perform a corresponding open- and/or closed-loop control function, e.g. operating a heating valve, activating or deactivating the cooling unit of an air-conditioning system, switching a fan on or off, operating the adjustment of a blind, dimming the lighting and others.

The disadvantageous factor in the EIB is the high constructional complexity of the individual components, all of which have their own microprocessor. All tasks require the installation of separate components, the connection of which by means of a special cable necessitates high installation expenditure. The basic functions of the components are fixed. They do not offer much margin for parametrization, i.e. individual adjustment of functions, which is why the flexibility of the system leaves something to be desired. The decentralized bus structure does not allow the operator to configure the system freely. Instead, configuration is up to authorized technical personnel. However, many installers shy away from the high initial costs and the time-consuming programming. Although the EIB has been used successfully in large buildings with predominantly commercial utilization, it has not had the wide success in the construction of private houses and residences, especially in smaller units.

To round off the EIB, the Powerline EIB was developed. It allows those components to be included in the bus system, of which the cabling can no longer be changed. The Powerline EIB is based on the concept of handling the data exchange between the components on a narrowband base via the electrical power line. This is far from being technically perfected. A particularly critical factor is the attenuation of the bus signal propagating along the power line by every individual electrical load. Transmitting power and frequency band are greatly restricted by official rules and the data transmission rate is low. For this reason, a data cable must be generally preferred to the Powerline EIB as a bus connection.

According to the present state of the art, remote control systems based on radio only can act only on one or a few actuator(s). The comprehensive open- and/or closed-loop control functions of a bus system are not achieved. The reliability of radio transmission leaves something to be desired and their physiological effects are not fully known.

Last but not least, high investment costs stand in the way of a wide use of radio remote controls.

Furthermore, the PHC (PEHA House Control by the company PEHA) bus is known for automating building services. This bus is intended for relatively small objects, particularly single- and multi-family houses. It has a central device which is usually accommodated in the fuse box and performs all closed- and/or open-loop control functions.

The disadvantageous factor in the PHC bus is that every sensor and actuator must be connected to it individually. This entails a large installation effort. Due to the bus structure with a central intelligence, the possible applications of the PHC bus are restricted to a few simple signaling and operating functions.

As the most recent intelligent network for automating building services, the LCN (Local Control Network) was designed in which intelligent nodes communicate via a bus. The intelligence is structured to be decentralized. The LCN does not have a central device. Sensor and actuator functions are combined in LCN assemblies. To transmit data, a free wire of the electrical power line system can be used, if available.

The disadvantageous factor in the LCN is the constructional effort which is still very high due to the local intelligence native to each LCN assembly. Due to the bus structure with decentralized intelligence, free configurability by the operator is not easily available.

It is the object of the invention to create a device of the type initially mentioned which is distinguished by little expenditure on production and installation and provides the possibility of free configuration for the operator.

In the device achieving this object, a monitoring and/or measuring and/or closed-loop control and/or open-loop control module (room module) with integrated sensor system and one or more electrical power terminal/power terminals having no more than the poles of the electrical power lines each is provided for the room or each room. Between the room module(s) and a higher-level monitoring and/or measuring and/or closed-loop control and/or open-loop control module (central module), there is a data bus connection.

According to the invention, the complete sensor system and closed-loop control and/or open-loop control of the electrical power terminals for plug-in sockets, illumination and all possible actuating systems are combined on a single room module within one room in each case. The sensor system is an integral part of the room module. It can pick up temperature and/or brightness and/or air composition, particularly concentration of CO₂, other gases or smoke, and/or movement in the room. The actuating system is connected to the room module via the conventional, normally three-wire and sometimes also five-wire electrical power line system. The power terminals of the room module for plug-in sockets, illumination and actuating system can both be controlled on/off and the output voltage can be regulated and/or controlled continuously or in steps. Inasmuch as a data transmission between room module and actuating system is needed at all, this is carried out via one of the conductors of the electrical power line system, preferably the neutral conductor. Normally, the actuating system does not have any local intelligence. The actuating system can be configured and installed in a correspondingly conventional and uncomplicated manner by using standard components.

The room module of a room or the room modules of a number of rooms are connected via data bus to the central module. In a simple embodiment comprising one or a few room module(s), this is/these are directly on a data bus with the central module.

In an embodiment comprising a relatively large number of room modules, these can be on a data bus with a higher-level monitoring and/or measuring and/or closed-loop control and/or open-loop control module (distributor module) and at least two distributor modules can be on a data bus with the central module. At the distributor modules, the measurement values of the sensor system come together. The respective distributor module has the task of coordinating the regulating and/or control function of the room modules and it can also handle regulating and/or control and/or monitoring function at the higher level, for example of a working unit. This includes picking up the instantaneous and/or accumulated consumption of oil, gas, electricity, hot and cold water, compressed air, vacuum, coolants, etc., and monitoring the access to the working unit. For the latter purpose, the distributor module should be able to process the video signal of one or more monitoring camera(s). Since it is only the room modules with the distributor module which are on one data bus, the installation effort for the bus is small.

The distributor module enables the operator to access the configuration of the building services at the level of the respective working unit. The distributor module can be programmed. For this purpose, it can have a terminal for a PC, MAC, PDA or similar on which a user-friendly configuration software is running. All measurement values of the sensor system and the arrangement of the regulating and/or control functions linked to these are available to the operator. The operator can perform the configuring by himself in order to extend it if necessary and to adapt it to individual wishes and situations.

In a preferred embodiment, at least one distributor module communicates with the outside world. It can have a modem with an analog, ISDN, UMTS, GSM, radio or other suitable terminal for this purpose. Communication to the outside to a higher-level system is recommended for alarm messages from room monitoring and fault and service messages of the heating system and the air-conditioning system. The receiver of the message can be, for example, a computer, telephone, mobile telephone or UMTS terminal. Communication with the distributor module from outside enables selected functions to be remotely controlled.

The distributor modules of a number of working units are located on one data bus with the higher-level central monitoring and/or measuring and/or closed-loop control and/or open-loop control module (central module) of the building, building or plant complex. The measurement values of the sensor system of the entire unit come together at the central module. The central module has the task of coordinating the regulating and/or control functions of the distributor modules and it is able to handle regulating and/or control and/or monitoring functions at the higher level of the entire unit. This includes the entire outside monitoring, the monitoring of a central entry and exit area, a parking zone, a basement garage, regulating and/or controlling a central heating system and, if present, a power generation system, for example a solar installation, picking up the instantaneous and/or accumulated consumption of oil, gas, electricity, hot and cold water at the level of the entire unit and much more. The central module should be suitable for processing the video signal of one or more monitoring camera(s). Since it is only the distributor modules with the central module which are on one data bus, the installation effort for the bus is small.

Preferably, the central module can be programmed, too, and connected to a PC, MAC, PDA or similar for configuration. Configuration should be reserved for technical personnel who are responsible for the entire unit, for example the property manager.

In a preferred embodiment, the central module communicates with the outside world. It can have a modem with an analog, ISDN or GSM terminal for this purpose. Communication to the outside to a higher-level system is recommended for alarm messages from the building monitoring system and fault and service messages from the heating system, air-conditioning and solar system. The receiver of the message can be, for example, a computer, telephone, mobile telephone or a UMTS terminal. Communication from the outside allows selected functions to be remotely controlled.

Compared with conventional bus systems for automating building services, the invention considerably reduces the hardware expenditure and installation effort. This is achieved by combining the sensor system and the regulating and/or control functions for the actuating system of a room in one room module and the uncomplicated connection to it of conventional actuating systems without local intelligence via the electrical power line system, the data bus connection of the room modules to a central module or distributor module and, if necessary, the data bus connection of the distributor modules to the central module. Thus, an information flow and a regulating and/or control hierarchy is achieved which optimally reflect the actual accessing interests and capabilities.

The invention will be explained in greater detail in the text which follows, referring to exemplary embodiments shown in the drawing, in which, diagrammatically:

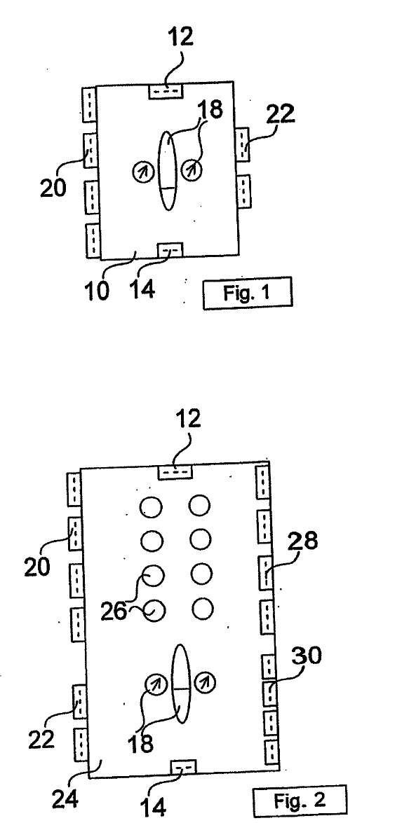

FIG. 1 shows the basic variant of a room module;

FIG. 2 shows the extended variant of a room module; and

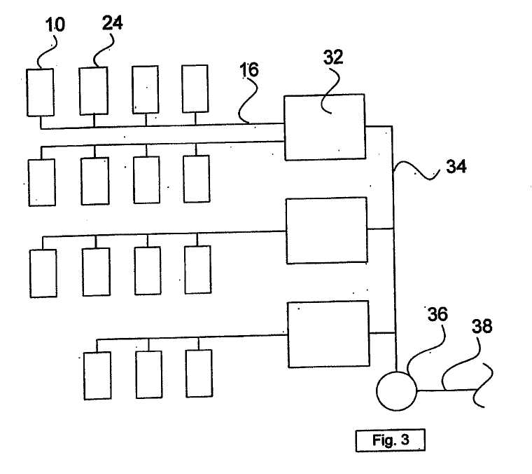

FIG. 3 shows a circuit in which a number of room modules are on one data bus with a distributor module and a number of distributor modules are on one data bus with a central module.

The room module 10 according to FIG. 1 has approximately the size of an installation switch. It thus fits behind a conventional single switch cover.

The space module 10 has a first input 12 for connection to the three-wire electrical power line system and a second input 14 for connection to a data bus 16. In the exemplary embodiment shown, the data bus 16 is a twisted two-wire cable. It can also be a fiber optical line, a power line, a radio link or similar.

The room module 10 has an integrated sensor system 18, e.g. for temperature, brightness, gases, movement. It also has six outputs 20, 22 for connection to plug-in sockets, illumination and many types of actuating systems in each case via a three-wire cable of the electrical power line system. Four outputs 20 are switched on/off and two outputs 22 are dimmed.

The room module 24 according to FIG. 2 has the approximate size of two installation switches. It thus fits behind a conventional double-switch cover.

The room module 24 additionally has six freely programmable keys 26 on the front panel, four inputs 28 for connecting conventional keys or switches via the three-wire electrical power line system and four low voltage inputs 30 for keys, door contacts, tele-communication and similar. In addition, the room module 24 can communicate with a remote control via radio or infrared. Low-voltage and line voltage circuits are strictly separated in the room module 24.

Room modules 10, 24 installed in one room each of a building working unit are located with the data bus 16 on a distributor module 32 which is accommodated in the fuse box of the working unit. The distributor module 32 can be implemented in various configuration levels and have a number of parallel data bus channels.

The distributor modules 32 of a number of working units are located on a common data bus 34 with a central module 36 of the entire building which is accommodated in its main distributing cabinet. In the exemplary embodiment shown, the data bus 34 is a twisted two-wire cable. It can also be a fiber optical line, power line, radio link or the like. The central module 36 can be implemented in various configuration levels and communicate with the outside world of the building 38.

### List of Reference Symbols

10 Room module
12 Power line input
14 Data bus input
16 Data bus
18 Sensor system
20 Terminal switched on/off
22 Dimmed terminal
24 Room module
26 Key
28 Power line input
30 Low-voltage input
32 Distributor module
34 Data bus
36 Central module
38 Communication with the outside world

1. A device for automating building services and possibly safety monitoring of a building, of an industrial plant, of a building and/or plant complex or a working unit thereof, which has at least one room, characterized in that a monitoring and/or measuring and/or closed-loop control and/or open-loop control module with integrated sensor system and one or more electrical power terminal/power terminals having no more than the poles of the electrical power line system each is provided for the or each room, and in that there is a data bus connection between the room module(s) and a higher-level monitoring and/or measuring and/or closed-loop control and/or open-loop control module.

2. The device as claimed in claim 1, characterized in that the room module is provided with integrated sensor system for temperature and/or brightness and/or air composition, particularly concentration of CO₂, other gases or smoke, and/or movement in the room.

3. The device as claimed in claim 1, characterized in that at least one power terminal of the room module can be controlled on/off.

4. The device as claimed in claim 1, characterized in that the output voltage of at least one power terminal of the room module can be regulated and/or controlled continuously or in steps.

5. The device as claimed in claim 1, characterized in that the room module(s) is/are on a data bus with the central module.

6. The device as claimed in claim 1, characterized in that at least two room modules are on a data bus with a higher-level monitoring and/or measuring and/or closed-loop control and/or open-loop control module and at least two distributor modules are on a data bus with the central module.

7. The device as claimed in claim 6, characterized in that the distributor modules are programmable.

8. The device as claimed in claim 6, characterized in that at least one distributor module communicates with the outside world.

9. The device as claimed in claim 1, characterized in that the central module is programmable.

10. The device as claimed in claim 1, characterized in that the central module communicates with the outside world.

11. A device for automating building services and possibly safety monitoring of a building, of an industrial plant, of a building and/or plant complex or of a working unit thereof, which has a number of rooms and in which a monitoring and/or measuring and/or closed-loop control and/or open-loop control module with integrated sensor system and one or more electrical power terminal/power terminals having no more than the poles of the electrical power line system each is provided for each room, wherein at least two room modules are on a data bus with a higher-level monitoring and/or measuring and/or closed-loop control and/or open-loop control module and at least two distributor modules are on one data bus with a higher-level monitoring and/or measuring and/or closed-loop control and/or open-loop control module.

12. The device as claimed in claim 11, characterized in that the room module is provided with integrated sensor system for temperature and/or brightness and/or air composition, particularly concentration of CO₂, other gases or smoke, and/or movement in the room.

13. The device as claimed in claim 11 wherein at least one power terminal of the room module can be controlled on/off.

14. The device as claimed in claim 11, wherein the output voltage of at least one power terminal of the room module can be regulated and/or controlled continuously or in steps.

15. The device as claimed in claim 11, wherein the distributor modules are programmable.

16. The device as claimed in claim 11 wherein at least one distributor module communicates with the outside world.

17. The device as claimed in claim 11, wherein the central module is programmable.

18. The device as claimed in claim 11, wherein the central module communicates with the outside world.
